(19) United States
(12) Patent Application Publication
(10) Pub. No.: US 2010/0217424 A1
(43) Pub. Date: Aug. 26, 2010

(54) CERAMIC CONTAMINATION CONTROL PROCESSES

(76) Inventors: Andrew Charles Gorges, Addison, NY (US); Sandra Lee Gray, Horseheads, NY (US); Vincent M. Leonard, Corning, NY (US); Brian Lewis, Pine Valley, NY (US); Michelle C. Peters, Corning, NY (US); David Lambie Tennent, Campbell, NY (US); Christopher John Warren, Waverly, NY (US)

Correspondence Address: CORNING INCORPORATED, SP-TI-3-1, CORNING, NY, 14831, US

(21) Appl. No.: 12/393,119

(22) Filed: Feb. 26, 2009

(51) Int. Cl. G06F 17/00

(52) U.S. Cl. 700/110

(57) ABSTRACT

Trace cross-contamination in mixtures or preforms of plasticized ceramic-forming powder mixtures, arising for example in manufacturing facilities where components of one ceramic product being manufactured can contaminate mixtures for another product to be manufactured, are controlled by one or more of: the targeted decontamination of shared production lines, rapid trace analysis of the mixtures to establish the presence and/or concentration levels of contaminants, the application of statistical models to project final product properties based on the analyzed concentrations, and decisional analysis of appropriate corrective actions based on the statistical projections.

### BACKGROUND

1. Field

The processes disclosed herein are in the field of ceramic manufacturing technology, and particularly relate to methods for manufacturing technical ceramic products meeting tight specifications for composition and physical properties through improved controls over the manufacturing environment.

2. Technical Background

Maintaining close control over the compositions and properties of engineered ceramics designed for advanced technical applications can be quite difficult in an industrial manufacturing environment. Examples of such ceramics include ceramic honeycombs of the types employed to control emissions from combustion engines, including ceramic honeycombs for the support of three-way catalysts in automobile exhaust systems and ceramic honeycomb filters used to trap particulates emitted by diesel engines. Ceramics for these applications have been engineered to meet tight tolerances for thermal expansion, strength and porosity, with close control over composition and crystal phase development being required to meet these tolerances. Control over these variables in turn requires careful attention to the surrounding manufacturing environment, in order to avoid the introduction of contaminants that can adversely affect crystal phase development, and thus the thermal expansion and porosity characteristics of the fired ceramics.

The business of manufacturing engineered ceramic honeycombs is capital-intensive. Modern production facilities for honeycomb production typically utilize dedicated production lines incorporating expensive equipment that is integrated to facilitate the continuous batching, batch-processing, extruding, drying, and firing of the products. Monitoring and controlling the compositions of the batch materials, and avoiding contamination of the products by foreign constituents present in most ceramic manufacturing environments are critical. Cordierite ceramics, of magnesium aluminosilicate composition and widely used to manufacture honeycomb catalyst supports for automobile exhaust systems, are good examples. Batch contamination by foreign oxides can result in cordierite products falling outside of manufacturing specifications for fired thermal expansion, even at parts-per-million levels of contamination.

Notwithstanding these difficulties, companies in the business of manufacturing technical ceramics can find it necessary or commercially advantageous to market products of a number of different compositions to suit a number of different applications. A present example of such a case arises in the production of ceramic honeycombs for engine emissions control applications. Although cordierite honeycombs have a long-established record of success as supports for gasoline engine emissions control catalysts, there are related applications, particularly involving the removal of particulates from diesel engine exhaust systems, where ceramics with different properties can offer certain performance advantages over cordierite. In particular, ceramic honeycombs of aluminum titanate and silicon carbide compositions are preferred by some diesel exhaust system manufacturers where honeycomb filters of higher refractoriness and/or higher heat capacity are needed. Another example of an alternative material for honeycomb manufacture is mullite, an aluminosilicate ceramic material offering cost and performance advantages for the manufacture of chemically and thermally durable filters for liquid filtration in the food and beverage industries.

Although the demand for ceramics of alternative composition can be substantial, there are many cases where such demand cannot justify the costs of constructing and maintaining separate production lines for such compositions. Thus the problem is whether, and if so to what extent, multiple ceramics could be successfully and economically manufactured on a single production line. Obviously, substantial production losses due to cross-contamination of the ceramic batches that result in a failure of the products to meet tight product performance specifications cannot be tolerated. At the same time, the costs of complete line disassembly and decontamination, and the losses from production that could be incurred in the event of an incomplete or ineffective decontamination, are prohibitive. Thus there is a clear need for methods and systems that could enable the successful sharing of such production facilities.

### SUMMARY

The processes hereinafter disclosed provide flexible solutions for addressing the above described problems. Included are methods and procedures for detecting and preventing the cross-contamination of one ceramic composition by trace materials from another ceramic composition processed in the same manufacturing facility and/or produced using the same manufacturing equipment. Thus embodiments of the methods disclosed herein enable the production of two or more ceramic products of differing composition on the same production line even where the levels of acceptable contamination of the products are quite low. Further, embodiments of the disclosed methods are provided that reduce the risk of incurring full production costs for out-of-specification products resulting from the undetected presence of small but harmful levels of batch contamination.

In accordance with a number of embodiments described herein, methods for preventing cross-contamination as between multiple ceramic compositions selected for manufacture on a single production line generally include a preliminary step of identifying potential cross-contamination sites or “dead zones” within the production line. Identification may involve, for example, conveying a plasticized material incorporating a marking additive through the production line, thereafter purging the line of the plasticized material, and finally scanning the production line for residue of the marking additive.

Given knowledge of the locations of cross-contamination sites within the production line thus obtained, sets of samples of any one of the ceramic compositions entering into production on the line may be selectively collected from those sites only. The collected samples are then analyzed to establish levels of any cross-contaminant present therein that have been derived from residues of other ceramic compositions previously in production on the line.

Carrying out selective sampling in the early stages of a production switch-over enables the early detection of unacceptable contamination levels and greatly reduces the likelihood of incurring further manufacturing costs relating to the processing of ceramic ware not likely to meet final product specifications. Further, while sampling from locations other than cross-contamination sites is certainly permissible, such sampling has a low probability of identifying sources of harmful contamination, and thus involves unnecessary time and expense.

While approaches for dealing with a particular contamination issue may vary, best operational practice may dictate that principles of decision analysis be applied. For example, some embodiments disclosed herein utilize a decision tree, embodied in a tree diagram where expedient, to facilitate the selection of one of a set of predetermined strategic steps most likely to reduce costs. More specifically, the level of cross-contaminant analyzed in sets of samples collected above described can be used to dictate one of a defined group of corrective action steps.

Examples of corrective action steps that may be selected include (i) selectively extracting additional samples of the ceramic composition from the cross-contamination sites and re-determining cross-contamination levels, or (ii) segregating the finished products of the contaminated ceramic composition taken from the production line pending testing of one or more physical properties of the finished products to determine adherence to product specifications, or, in worst cases (iii) purging the production line of that ceramic composition pending further decontamination of the line.

As the art is aware, it is seldom practical, or even possible, to reduce contamination levels to zero in commercial ceramic manufacturing environments. Accordingly, where a first ceramic composition includes one or more ingredients that are potentially effective at some concentration to interfere with the successful manufacture of a second ceramic composition, the identities and concentrations of the interfering ingredient(s) must first be ascertained. Embodiments of the present therefore include methods for manufacturing first and second ceramic products of differing first and second ceramic composition on a single production line that comprise the preliminary steps of (i) identifying a potential cross-contaminant present as an ingredient of the first ceramic composition, and thereafter (ii) establishing a permissible cross-contamination level for that cross-contaminant in a second ceramic composition.

Establishing permissible cross-contamination levels is effectively carried out by correlating physical properties changes with contaminant concentrations over a range of concentrations that may be encountered in production. The resulting correlations enable the accurate projection of the direction and magnitude of changes in one or more physical properties of a ceramic product that would result from the processing of any particular contaminated ceramic precursor or precursor mixture without actually evaluating a finished product, provided only that the concentration of an identified cross-contaminant in the precursor mixture is first determined.

A systematic procedure that enables such projections to be made comprises, first, preparing a benchmark series of ceramic products of a common base composition but differing concentration levels of the identified contaminant. One or more selected physical properties for each of the products in the series are then measured, and a statistical model is constructed that will correlate the differing concentration levels of contaminant with the measured physical properties of the products. Thereafter, the resulting statistical model is used to project one or more physical properties of a further ceramic product of the model base composition to be manufactured, given only the concentration of the contaminant measured in a ceramic precursor or precursor mixture compounded for the purpose of manufacturing that product.

It is particular advantage of statistical modeling, as hereinafter more fully described, that properties variations can be predicted even in cases where trace contamination levels are involved. For purposes of the present description, trace contamination levels include contamination at levels of 1% by weight and below of the ceramic precursor or precursor mixture. Another advantage is that multiple physical properties changes can readily be projected through the use of multiple statistical models constructed from evaluations of multiple physical properties changes on a single benchmark series of ceramic products.

Cross-contaminants of concern for the production of ceramic products such as ceramic honeycombs include those ingredients of the first ceramic composition that will affect any one of a set of key physical properties for products made from a second composition. Such properties include one or more of: ceramic crystal phase development during a firing of the second ceramic composition; firing shinkage of the second ceramic composition; a coefficient of thermal expansion value of a ceramic product made from the second ceramic composition; a porosity characteristic of a ceramic product made from the second ceramic composition, and a modulus of rupture strength characteristic of a ceramic product made from the second ceramic composition. Specifications for ceramic honeycomb products made from ceramic materials such as described in more detail below routinely include limited ranges for thermal expansion, porosity and strength.

Once the identities and permissible levels of contaminants have been determined, the further steps of mapping one or more cross-contamination sites on the production line, and then decontaminating one or more of those cross-contamination sites through a removal of trace residues of the first ceramic composition therefrom, can be carried out prior to manufacturing the second ceramic composition on the production line. Again, to insure against possible residual contaminating ingredients, samples of the second ceramic composition are extracted from one or more of the cross-contamination sites, and the level or levels of cross-contamination present in those samples are determined.

In any ceramic manufacturing facility where production lines or production equipment from those lines is to be shared, it will of course become necessary to repeat these decontamination procedures when converting the line from production of the second ceramic composition back to production of the first ceramic composition. Thus, as regularly practiced, the foregoing method will include the additional steps of identifying a second cross-contaminant present as an ingredient of the second ceramic composition, establishing a permissible cross-contamination level for the second cross-contaminant in the first ceramic composition, and then decontaminating one or more of the cross-contamination sites to remove the second cross-contaminant prior to commencing production of the first ceramic composition on the production line. Further, once such production has commenced, the further steps of selectively extracting samples of the first ceramic composition from one or more of the cross-contamination sites, and determining a cross-contamination level from the samples of the first ceramic composition, are carried out.

To insure that cross-contamination levels may be accurately determined on a real time basis, analytical methods that include subjecting samples of possibly contaminated ceramic compositions (e.g., precursor mixtures or even product preforms shaped from such mixtures) to a rapid and accurate trace analysis are required. For this purpose, laser-induced breakdown spectrographic (LIBS) analyses can provide an effective approach. LIBS methods can be efficiently applied to production line mixtures or product preforms in situ, that is without special sample preparation procedures or removal of the samples to laboratory facilities. Thus multiple on-line or “near-line” analyses can be quickly and accurately carried out utilizing small samples taken from multiple production line locations where contamination might potentially arise. Moreover, such analyses can detect the presence or absence of one or more contaminants in precursor mixtures or preforms even at those trace concentration levels giving rise to unacceptable changes in product properties.

An important aspect of the disclosed methods involves successfully identifying and selectively treating potential sources of contaminating material within shared production lines. Thus, in a further aspect, the disclosed embodiments include a method for maintaining a ceramic production line free of contaminating materials comprising, first, conveying a shapeable mixture incorporating a marking material through the production line. Thereafter, the production line is substantially purged of the mixture, and then at least partially disassembled to identify contamination sites therewithin that retain residual marking material following the purge. Those retention sites are then mapped for future selective treatment and removal of any contaminating material from a first ceramic production run on the production line prior to the initiation of a second ceramic production run on the production line.

Through the use of the above described methods, the production of two dissimilar and even mutually incompatible ceramic compositions can be carried out on the same production equipment with a very high probability of success for the manufacture of in-specification products of both compositions. Thus shared production equipment may be economically transitioned from the processing of a first composition to a second composition and then back again to the first composition without any requirement to modify either of the compositions for the purpose of improving the tolerance of one of the compositions against cross-contamination from the other.

### DESCRIPTION OF THE DRAWINGS

The foregoing methods are further described below with reference to the appended drawings, wherein:

FIG. 1 schematically illustrates process flow through a ceramic production line of illustrative design; and

FIG. 2 plots contamination levels for a representative contaminant in a commercial honeycomb composition.

### DETAILED DESCRIPTION.

While the methods disclosed herein have broad application to the management of ceramic production operations over a relatively wide range of differing manufacturing environments and types of ceramic products, they may be applied with particular advantage to the production of extruded ceramic honeycombs of differing composition on the same production line. Thus the following description and examples frequently reference such production even though offered for purposes of illustration only and without any intention to limit the application of the methods herein disclosed to any particular composition or product.

For the production of ceramic honeycomb products of current commercial importance, ceramic compositions that are convertible through firing to a ceramic material having a predominant crystal phase selected from the group consisting of cordierite, aluminum titanate, mullite, and silicon carbide are used. By a predominant crystal phase is meant a phase constituting at least 50% by weight of the fired material. These compositions again typically comprise inorganic powders, optional organics such as carbon, binders and lubricants, and liquid vehicle constituents (e.g., water) in proportions suitable for forming plasticizable mixtures.

An illustrative example of a cross-contamination problem arising during attempts to manufacture more than one of these compositions on a single production line is that occurring between compositions convertible to cordierite and those convertible to aluminum titanate. In that case the potential for contamination is particularly problematic because it can occur in both directions. In the first instance, unacceptable contamination can occur when the first ceramic composition processed through the production line is convertible through firing to a predominantly aluminum titanate ceramic, and the second ceramic composition is convertible through firing to a predominantly cordierite ceramic. There, residual aluminum titanate batch material has been found to interfere with cordierite phase development during later firing.

In the second instance, harmful contamination can occur when the first ceramic composition processed through the line is convertible through firing to a predominantly cordierite ceramic, and the second ceramic composition is convertible through firing to a predominantly aluminum titanate ceramic. Contamination in that case interferes with aluminum titanate phase development. The damaging effects in these instances can include increases in the thermal expansion of ceramic products made from the contaminated ceramic compositions as well as changes in the porosity of the final products.

The particular contaminants most likely to affect these and other product properties of ceramics presently being used for ceramic honeycomb manufacture are the alkaline earth metal elements. Silicon and aluminum are unlikely to cause harmful effects since they are common constituents of both of these composition families.

We have identified the cross-contaminant having the largest effect on aluminum titanate ceramic properties as the MgO component of cordierite batch mixtures. The cross-contaminant having the largest effect on cordierite ceramic properties is found to be the SrO component of aluminum titanate batch mixtures, although CaO present in such mixtures can also be problematic.

The fundamental processes of ceramic honeycomb manufacture are well established, and production lines adapted for the manufacture of those products frequently share common design and equipment features. Fundamental process steps include, first, the dry-blending of particulate solids selected to form a target ceramic composition, those solids typically comprising one or more of: mineral feedstocks, oxides, carbides, compounds convertible to oxides or carbides at high temperatures, carbon powders, dry lubricants, and the like. Liquid vehicle and binder constituents are then added to the dry-blend with preliminary mixing to form a wet, semi-solid mass. The resulting pre-mix is then extensively worked in equipment designed to produce a smooth paste having a plastic consistency suitable for extrusion through a honeycomb extrusion die.

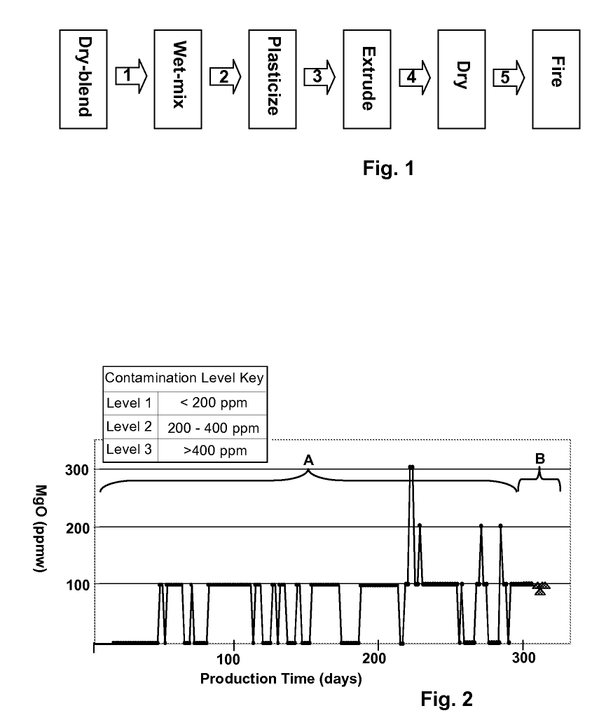

The equipment used to plasticize the mixture may vary, but single-screw and twin-screw extruders are frequently employed for the purpose since they can simultaneously effect plasticization and develop delivery pressures adequate for honeycomb extrusion in a single production unit. FIG. 1 of the drawing is a block diagram outlining the principal and conventional stages of a typical honeycomb production process. That process as shown commences with dry-blending and continues through wet-mixing, plasticization, honeycomb extrusion, drying, and firing as above described. Arrows 1-5 in FIG. 1 represent transitional actions of transport or product preform handling occurring in the course of manufacture.

A number of possible SITES sources of contamination having at least the potential for adversely affecting ceramic honeycomb quality can be identified with reference to the production stages illustrated in FIG. 1. These include: (i) dry-blending equipment employed in the dry-blending stage, (ii) weighing equipment employed during the transport (arrow 1) of the dry-blend mixture to the wet-mixing stage; (iii) mixers (e.g., Littleford mixers) involved in the wet-mixing stage; (iv) metering and conveying equipment employed to meter and transport the wet mix into the equipment used to plasticize and then extrude the mixture into honeycomb shapes, such as a twin-screw extruder (arrow 2), and (v) sections of the extruder used for the extrusion of the honeycomb shapes.

Given these possible cross-contamination sources, the sampling of material from at least the dry-blending stage, the dry-blend transport and/or weighing equipment (arrow 1), the wet-mix handling equipment (arrow 2), and extrudate issuing from the extrusion stage (arrow 4) would be would be appropriate following a composition switch-over. Of course, where any item of production equipment can be dedicated to the handling of only one composition, e.g. dedicated dry-blend equipment, decontamination and post-switchover testing would not be required.

While contamination sufficient to impact fired honeycomb quality is less likely to occur during the drying and firing stages of production, such contamination cannot be ruled out. That is because the zones within any particular production line that can constitute contamination or cross-contamination sites will vary somewhat depending upon the designs of the particular items of equipment utilized to perform each of the required process steps. As noted above, however, the locations of the cross-contamination sites to be mapped for decontamination in any particular production line may be identified by adding a marker to a charge of powder, liquid or plasticized mixture, e.g., a first ceramic composition, processing that composition through the production line, purging the line of the first ceramic composition, and finally identifying cross-contamination sites from residues of the marker left in the production line after purging and/or preliminary line cleaning. Suitable markers for the purpose can consist of colorants that will provide a simple visual indication of residue, or other persistent additives that can be located by physical or chemical means.

The decontamination of cross-contamination sites in preparation for a conversion from the production of a first ceramic composition to a second ceramic composition is likewise initiated by purging the production line of the first ceramic composition. In addition to a thorough purging and preliminary cleaning of the line, a selective decontamination/cleaning of the internal surfaces of any items of production line equipment harboring cross-contamination sites can be carried out. Such selective decontamination steps can improve the level of protection against possible cross-contamination of the second composition, at least at levels likely to unacceptably impact the properties of the resulting products.

Following second composition start-up, the selective extraction of samples of the second ceramic composition from one or more of the cross-contamination sites in the course of early production, and the prompt determination of levels of any cross-contamination of those samples, is key to securing the economic advantages of the disclosed method. Concentrating attention upon the most likely sources of contamination, especially at upstream locations on the production line, and then quickly selecting an appropriate corrective action step, enables the producer to avoid the very costly drying and firing of ware having a very low probability of meeting product specifications.

The step of establishing a permissible concentration level for the cross-contaminant in the second ceramic composition is likewise important, as it can prevent the unnecessary recycling or scrapping of material that, despite trace levels of contamination, can still be processed to produce in-specification products. Most effective is the practice of defining multiple levels of potential cross-contamination, scaled to the risk of quality problems in the finished products, that can guide corrective action properly scaled to the level of cross-contamination encountered.

In many cases, low levels of contamination can be addressed by simply continuing to monitor levels as production continues, e.g., by selectively extracting additional samples of the second ceramic composition from the cross-contamination sites and re-determining the cross-contamination levels until they are no longer of concern. Intermediate levels of contamination may not require a production interruption either, since product quality concerns can be addressed, for example, by segregating the finished products of the second ceramic composition produced at those levels pending the testing of key physical properties of those products. Thus only in cases of highest contamination may the purging of the contaminated composition from the production line become necessary.

As noted above, cordierite and aluminum titanate are examples of first and second ceramic products that are potential candidates for manufacture in a common production facility, since each of these materials is presently used for the manufacture of ceramic honeycombs for the construction of diesel engine exhaust filters. Also noted was the fact that magnesium oxide (MgO), which is present in large proportion in cordierite ceramic precursor mixtures, can adversely affect the properties of aluminum titanate ceramics, while strontium oxide (SrO), present in some commercial aluminum titanate ceramic precursor mixtures, can adversely affect cordierite ceramic properties.

Establishing the effects on final (fired) product properties of various levels of either of these contaminants introduced into wet or dry batch mixtures, or into product preforms in the green or unfired state, can be accomplished by statistical methods. One such approach involves the development of statistical models utilizing analysis of variance statistical tools such as ANOVA software to model contamination effects on fired properties.

Properties of particular interest for particulate filter applications include coefficient of thermal expansion, firing shrinkage, percent porosity, mean pore size, and pore size distribution. Statistical models can provide useful predictions of the contamination levels that will cause unacceptable changes in any one of these properties. That information can be used, for example, to determine when shared equipment is “clean enough” to produce ware that can be processed to a finished state without an undue risk of a failure to meet a final product specification for one of the above properties. The following example describes the development and use of two such models.

### EXAMPLE

To generate data for the development of models correlating cross-contamination levels with the fired properties of cordierite and aluminum titanate ceramic products, a benchmark series of batch compositions for each of these two products is prepared. Known levels of contamination are introduced into each series via small additions of batch material from the other, i.e., small quantities of aluminum titanate batch mixture are introduced into the cordierite series, and small additions of the cordierite batch mixture are introduced into the aluminum titanate series. This method of controlled contamination is appropriate because the contamination of one ceramic precursor mixture being processed in a shared manufacturing environment most typically occurs through contact with residual precursor mixtures from the manufacture of a second ceramic product of differing composition, rather than from the introduction of a single oxide or other compound.

Each benchmark series of fired ceramics thus provided includes products made from 20 different batches of increasing cross-contamination level, those batches being compounded to include as much as 1% of the cross-contaminating batch, or from hundredths to tenths of one percent of cross-contaminating MgO or SrO. Table 1 below sets forth data resulting from the mixing, extrusion, drying and firing of honeycomb samples of aluminum titanate composition contaminated with MgO. Included in Table 1 for each of twenty sample honeycomb compositions is a batch contamination level, a resulting MgO contamination level, and data reflecting the effects of each contamination level on six different physical properties, each averaged for a group of five contaminated honeycomb samples. Values reported for the uncontaminated samples are averages for fifteen honeycomb samples.

The properties reported in Table 1 include percent firing shrinkage (% height change and % diameter change), average thermal expansion (CTE) of the fired ceramics at two elevated temperatures (800° C. and 1000° C.) in units of 10⁻⁷/° C., the average porosity in percent of sample volume, the average mean pore size (MPS) in micrometers (corresponding to the pore diameter D₅₀ below which one half of the pore volume of the sample resides and above which the other half resides), and a porosity distribution factor (D-factor) equal to the ratio (D₅₀-D₁₀)/D₅₀ , D₁₀ being the pore diameter below which 10% of the sample pore volume resides.

TABLE 1
MgO Contamination Effects in Aluminum Titanate Products

| | MgO | | | | | | | |
|---|---|---|---|---|---|---|---|---|
| Batch | contamination | Height | Diameter | | | | | |
| Contamination | (%- | Change | Change | CTE @ | CTE @ | Porosity | MPS | |
| (PPM-wt) | wt) | (%) | (%) | 800° C. | 1000° C. | (%) | (μm) | D-Factor |
| 0 | 0.027 | 0.237 | 0.328 | 2.94 | 6.92 | 50.09 | 15.12 | 0.4 |
| 100 | 0.028 | 0.229 | 0.339 | 3.26 | 7.38 | 50.23 | 15.53 | 0.418 |
| 250 | 0.032 | 0.309 | 0.477 | 3.54 | 7.50 | 49.62 | 15.26 | 0.398 |
| 500 | 0.032 | 0.433 | 0.686 | 4.56 | 8.72 | 50.22 | 15.06 | 0.392 |
| 750 | 0.036 | 0.558 | 0.737 | 4.50 | 8.58 | 50.72 | 15.26 | 0.41 |
| 1,000 | 0.039 | 0.475 | 0.679 | 5.28 | 9.42 | 50.17 | 15.38 | 0.398 |
| 1,250 | 0.042 | 0.435 | 0.675 | 5.36 | 9.40 | 49.92 | 15.19 | 0.394 |
| 1,500 | 0.046 | 0.483 | 0.711 | 5.38 | 9.36 | 50.09 | 15.02 | 0.396 |
| 1,750 | 0.053 | 0.472 | 0.664 | 6.56 | 10.66 | 49.54 | 15.17 | 0.382 |
| 2,000 | 0.055 | 0.605 | 0.829 | 6.34 | 10.42 | 50.39 | 15.22 | 0.402 |
| 2,250 | 0.061 | 0.590 | 0.825 | 6.56 | 10.60 | 50.19 | 15.20 | 0.398 |
| 2,500 | 0.067 | 0.568 | 0.842 | 7.40 | 11.56 | 50.56 | 15.15 | 0.404 |
| 0 | 0.027 | 0.188 | 0.371 | 2.60 | 6.54 | 50.18 | 14.95 | 0.41 |
| 3,750 | 0.082 | 0.618 | 0.873 | 8.02 | 11.78 | 50.13 | 14.89 | 0.4 |
| 5,000 | 0.1 | 0.409 | 0.671 | 9.38 | 13.38 | 50.48 | 15.19 | 0.384 |
| 6,250 | 0.12 | 0.326 | 0.504 | 9.30 | 13.52 | 50.88 | 15.29 | 0.404 |
| 7,500 | 0.14 | 0.241 | 0.411 | 10.80 | 14.96 | 50.00 | 15.30 | 0.372 |
| 8,750 | 0.16 | −0.084 | 0.015 | 10.64 | 14.96 | 49.27 | 15.02 | 0.356 |
| 10,000 | 0.18 | −0.160 | −0.055 | 10.80 | 14.96 | 49.51 | 15.05 | 0.36 |
| 0 | 0.026 | −0.005 | 0.044 | 2.96 | 6.50 | 50.66 | 15.26 | 0.418 |

Table 2 below reports corresponding contamination level and physical properties changes for an equivalent number of cordierite honeycomb samples contaminated with SrO from small aluminum titanate precursor batch additions to the base cordierite precursor batch mixture.

TABLE 2
SrO Contamination Effects in Cordierite Products

| | SrO | | | | | | | |
|---|---|---|---|---|---|---|---|---|
| Batch | contamination | Height | Diameter | | | | | |
| Contamination | (%- | Change | Change | CTE @ | CTE @ | Porosity | MPS | |
| (PPM-wt) | wt) | (%) | (%) | 800° C. | 1000° C. | (%) | (μm) | D-Factor |
| 0 | 0.000 | −0.273 | 0.041 | 4.88 | 6.80 | 37.20 | 3.66 | 0.69 |
| 100 | 0.000 | −0.202 | 0.044 | 4.92 | 6.90 | 38.38 | 3.58 | 0.69 |
| 250 | 0.005 | −0.252 | 0.004 | 5.34 | 7.30 | 37.92 | 3.64 | 0.68 |
| 500 | 0.007 | −0.243 | −0.103 | 4.50 | 6.78 | 37.76 | 3.64 | 0.67 |
| 750 | 0.008 | −0.241 | 0.02 | 5.06 | 7.10 | 38.22 | 3.72 | 0.67 |
| 1,000 | 0.009 | −0.297 | −0.037 | 5.22 | 7.06 | 38.26 | 3.68 | 0.68 |
| 1,250 | 0.010 | −0.242 | 0.013 | 5.24 | 7.26 | 36.72 | 3.58 | 0.68 |
| 1,500 | 0.011 | −0.192 | 0.109 | 5.28 | 7.10 | 37.32 | 3.60 | 0.68 |
| 1,750 | 0.012 | −0.151 | 0.078 | 5.34 | 7.22 | 37.82 | 3.58 | 0.68 |
| 2,000 | 0.014 | −0.203 | 0.135 | 5.18 | 7.16 | 37.70 | 3.68 | 0.68 |
| 2,250 | 0.015 | −0.21 | 0.086 | 5.30 | 7.14 | 37.80 | 3.48 | 0.66 |
| 2,500 | 0.016 | −0.167 | 0.113 | 5.28 | 7.18 | 37.54 | 3.48 | 0.67 |
| 0 | 0.000 | −0.254 | 0.014 | 5.16 | 7.38 | 37.48 | 3.61 | 0.69 |
| 3,750 | 0.025 | −0.217 | 0.088 | 5.24 | 7.14 | 38.82 | 3.44 | 0.66 |
| 5,000 | 0.029 | −0.226 | 0 | 5.00 | 6.74 | 37.98 | 3.50 | 0.65 |
| 6,250 | 0.034 | −0.074 | 0.245 | 5.74 | 7.52 | 38.82 | 3.44 | 0.67 |
| 7,500 | 0.040 | −0.232 | 0.059 | 5.26 | 7.06 | 37.98 | 3.52 | 0.66 |
| 8,750 | 0.046 | −0.193 | 0.106 | 5.00 | 6.88 | 38.76 | 3.50 | 0.65 |
| 10,000 | 0.051 | −0.132 | 0.148 | 5.34 | 7.06 | 38.78 | 3.46 | 0.64 |
| 0 | 0.000 | −0.216 | 0.046 | 5.04 | 6.86 | 37.74 | 3.66 | 0.68 |

As indicated by the data in Tables 1 and 2 above, the effects of batch contamination on the physical properties of cordierite and aluminum titanate ceramics vary depending upon the composition of the batch and batch contaminant being evaluated as well as on the particular physical property being measured. Some properties may show large and progressive changes with increasing contaminant levels, while others may show no significant change or change pattern despite relatively large contaminant additions.

The observed variations in cross-contamination effects indicated by the data in Tables 1 and 2 are reflected in statistical models developed from those data. Tables 3 and 4 below set forth model-based equations enabling the prediction of selected physical properties, respectively, of fired aluminum titanate ceramics containing an MgO contaminant, and fired cordierite ceramics containing an SrO contaminant. In those cases where contamination effects on a particular physical property are minimal or without a statistically significant correlation to contamination levels, no modeling equation is provided. While predictions based on these equations are subject to some degree of uncertainty, a range of values for any of the listed properties can generally be calculated within a selected degree of confidence, that degree of confidence being considered appropriate for evaluating the risk that products fired from a particular contaminated batch material will fail to meet a set final property specification.

TABLE 3
Properties of Aluminum Titanate (+MgO) Ceramics

| Fired Ceramic Property | Model Based Equation |
|---|---|
| Height Change (%) | −0.061162 + 15.08323 * Wt. % MgO − 91.17967 (Wt. % MgO)² |
| Diameter Change (%) | −0.016424 + 19.64691 * Wt. % MgO − 116.25135 * (Wt. % MgO)² |
| D-factor | +0.41400 − 0.28378 * Wt. % MgO |
| CTE @800 | −0.039308 + 137.14116 * Wt. % MgO − 435.80598 * (Wt. % MgO)² |
| CTE @1000 | +3.89374 + 138.86923 * Wt. % MgO − 436.24506 * (Wt. % MgO)² |
| Porosity | +49.79670 + 14.02837 * Wt. % MgO − 89.89216 * (Wt. % MgO)² |

TABLE 4
Properties of Cordierite (+SrO) Ceramics

| Fired Ceramic Property | Model Based Equation |
|---|---|
| Height Change (%) | −0.23934 + 1.71626 * Wt. % SrO |
| Diameter Change (%) | +0.019298 + 2.47901 * Wt. % SrO |
| D-factor | +0.68466 − 0.79295 * Wt. % SrO |
| Porosity | +37.58407 + 22.04402 * Wt. % SrO |
| MPS | +3.64009 − 4.06569 * Wt. % SrO |

As the equations in Tables 3 and 4 suggest, model-based equations for projecting physical properties from known contamination levels in ceramic systems such as described are generally based on linear regression models of not more than two regressors. Higher order terms have not been found to provide equations offering higher R2 coefficients, and thus offer no significant benefits in terms of improved projection accuracy. Linear regression models comprising model-based equations of the form Y=C0+C1(% X)+C2(% X̂2), wherein Y is the projected physical property, C0, C1 and C2 are constants, and % X is the known concentration of the contaminant, are generally quite suitable for the purpose of these methods.

Permissible cross-contamination levels for a particular cross-contaminant known to originate from cordierite or aluminum titanate ceramic precursor mixtures can also be established through a study of baseline production data. Such data can consist of analytical results accumulated during routine production of a particular ceramic product, or can be generated through a program of testing historically retained production samples. In the case of cordierite/aluminum titanate cross-contamination, the most useful analytical markers for establishing baseline and permissible cross-contamination levels, as well as for monitoring higher contamination levels in production, are analyzed levels of the contaminating elements themselves.

FIG. 2 of the drawings is a graph plotting illustrative analytical MgO marker data such as would be collected by sampling during the prolonged production of an aluminum titanate-type ceramic composition on a production line previously used for cordierite honeycomb production. The horizontal axis in FIG. 2 plots production run time in days, while the vertical axis plots MgO marker concentration in parts per million by weight. The concentrations reported are as would be determined by chemical analysis of wet-mix samples collected from a conveyer belt transporting pre-mixed ceramic batch material to the inlet of a twin-screw extruder. Also presented in FIG. 2 is a table of predetermined contaminant Levels 1-3, tables of this type being operationally advantageous for consistently selecting corrective action steps appropriate to the level of contamination detected in any particular selective sampling of a ceramic material in production.

Section A of the sampling data reported in FIG. 2 is so-called “baseline” data, i.e., data showing MgO concentrations over a relatively long period of aluminum titanate ceramic processing. The MgO levels shown during the baseline period are generally below those that would affect the thermal expansion properties of fired aluminum titanate ceramics produced from the composition being processed, being within contamination Level 1 in the table and thus being considered “permissible”. Instances of Level 2 contamination are seen in the 200+day segment of the production run, and in those intervals a segregation of finished products for properties testing prior to release could be a prudent corrective action.

Section B of the marker data includes some contamination level values represented by triangular data points. Those points are representative of MgO analysis data collected during the initial processing of an aluminum titanate ceramic mixture through a production line incorporating a large twin-screw extruder previously dedicated to cordierite honeycomb production. The data shown is representative of analytical results collected during an initial aluminum titanate production period immediately following a line purge of the cordierite ceramic material, and if necessary a further line cleaning that may additionally include a selective decontamination of cross-contamination sites in the production line. Typically only Level 1 contamination is seen following purging and decontamination procedures such as described.

Results similar to those presented above for the control of MgO contamination in aluminum titanate ceramic compositions can be achieved utilizing the same decontamination and monitoring practices to address SrO and/or CaO contamination in cordierite compositions. For example, following the termination of aluminum titanate production on the production line used to generate the Section B MgO marker tracking data shown in FIG. 2, the line may be reconverted to cordierite production. Again, production will be initiated only following line purging of the aluminum titanate ceramic batch material, together with a line cleaning that includes the decontamination of potential cross-contamination sites on the line.

The selective sampling of cordierite ceramic batch materials from those cross-contamination sites, aimed at detecting and determining levels of possible CaO contamination of the cordierite material, is commenced shortly after the initiation of cordierite production. Representative results of CaO marker tracking under the described conditions indicate Level 1 and Level 2 CaO contamination only, and with all instances of Level 2 CaO contamination being near the lower end of the Level 2 range. Thus only continued close monitoring of marker levels, or in some cases a limited selective segregation of finished cordierite honeycomb products for physical properties testing, are ordinarily necessary to achieve a successful line reconversion to cordierite.

Responding promptly and effectively to the appearance of honeycomb batch contamination requires the timely collection of quantitative analytical data concerning the level of contamination to be addressed. Samples for generating these data are best collected at frequent intervals and from multiple potential contamination sites in the production environment, leading to a requirement for the rapid testing of a large volume of samples to measure trace concentrations of contaminants.

As noted above, analytical methods that include subjecting samples of ceramic precursor mixtures or product preforms to laser-induced breakdown spectrographic (LIBS) analysis are effective for addressing this need. LIBS methods can readily detect the presence of contaminants, and can quantify contamination levels, even at trace concentrations such as could occur during a production switchover between two different ceramic materials being processed on the same production line. Further, the ability to rapidly process multiple samplings means that locations in a production line where significant contamination is occurring can be quickly identified, limiting product and production time loss.

Further applications for laser breakdown spectroscopy in a production environment include routine use to track compositional changes normally occurring during the various stages of production. Changes in the concentrations of mixture components as well as structural or matrix changes in the materials being processed can occur at each stage of the manufacturing process, and spectrographic methods such as LIBS have the capability of detecting and quantifying these changes, with little need for extensive sample preparation in many cases.

A particular advantage of LIBS testing systems for these applications is that they are adaptable for use under automated control, and in manufacturing environments where analyses must be periodically repeated at a single one or at multiple production line locations. Further, the limited space requirements of appropriately designed LIBS systems make it possible to house suitable equipment at sites that can be locally controlled to maintain them substantially free of foreign particulates. For routine “near-line” production testing, samples can simply be removed, pelletized, and delivered to the testing equipment sites from many points on a production line.

Essential components of these spectrographic systems include a pulsed laser, a wavelength selector, and a radiant detector. The laser is capable of delivering a focused laser pulse that can achieve effective breakdown of a ceramic material. The emissions generated at breakdown are collected, separated by wavelength, and detected by an appropriate sensor.

Several types of optics are included as well, the laser optics being designed to withstand the high energy density of the ablation laser and to operate at the wavelength of the laser to avoid losses. The imaging optics are designed to handle the wavelength range for the particular material being analyzed.

Spectrometers for separating the light emitted by laser-activated sample are selected for high resolving power and to provide a large spectral window. System enclosures for the collected components are designed to contain reflected laser radiation and to prevent the intrusion of stray particulates from the manufacturing environment. With appropriate component selection, systems delivering the rapid sampling, data acquisition and result turnaround required for use as an on-line sensing and quantifying system for ceramic honeycomb production can readily be constructed.

While the foregoing descriptions include particular examples and embodiments of the disclosed methods, such examples and embodiments have been offered for purposes of illustration only, it being evident from the broader descriptions that a wide variety of alternative embodiments may be adopted by the artisan for particular purposes within the scope of the appended claims.

What is claimed is:

1. A method for manufacturing ceramic products of differing ceramic composition on a single production line which comprises the steps of:
identifying a cross-contaminant present as an ingredient of a first ceramic composition;
establishing a permissible cross-contamination level for the cross-contaminant in a second ceramic composition;
mapping one or more cross-contamination sites within the production line;
decontaminating one or more of the cross-contamination sites prior to manufacturing the second ceramic composition on the production line;
selectively extracting samples of the second ceramic composition from one or more of the cross-contamination sites, and
determining a cross-contamination level from the samples of the second ceramic composition.

2. A method in accordance with claim 1 comprising the further steps of:
identifying a second cross-contaminant present as an ingredient of the second ceramic composition;
establishing a permissible cross-contamination level for the second cross-contaminant in the first ceramic composition;
decontaminating one or more of the cross-contamination sites of the second cross-contaminant;
commencing production of the first ceramic composition on the production line;
selectively extracting samples of the first ceramic composition from one or more of the cross-contamination sites, and
determining a cross-contamination level from the samples of the first ceramic composition.

3. A method in accordance with claim 1 wherein the cross-contaminant is an ingredient affecting at least one of: (a) ceramic crystal phase development during a firing of the second ceramic composition; (b) firing shrinkage of the second composition; (c) a coefficient of thermal expansion value of a ceramic product made from the second ceramic composition; (d) a porosity characteristic of a ceramic product made from the second ceramic composition, and (e) a modulus of rupture strength characteristic of a ceramic product made from the second ceramic composition.

4. A method in accordance with claim 1 wherein the step of mapping one or more cross-contamination sites within the production line comprises the steps of (i) adding a marker to a charge of the first ceramic composition introduced into the production line; (ii) purging the production line of the first ceramic composition; and (iii) identifying the cross-contamination sites from residue of the marker in the production line.

5. A method in accordance with claim 1 wherein marker is a colorant.

6. A method in accordance with claim 1 wherein the step of decontaminating one or more of the cross-contamination sites includes the steps of (i) purging the production line of the first ceramic composition, and thereafter (ii) selectively cleaning internal surfaces of production line equipment harboring cross-contamination sites.

7. A method in accordance with claim 1 comprising executing one further step from a decision tree that includes the steps of:
(a) selectively extracting additional samples of the second ceramic composition from the cross-contamination sites and determining the cross-contamination levels in the additional samples; or
(b) segregating finished products of the second ceramic composition taken from the production line pending testing of a physical property of the finished products; or
(c) purging the production line of the second ceramic composition; and wherein the further step is selected based on the results of determining the cross-contamination level from the samples.

8. A method in accordance with claim 1 wherein the first and second ceramic compositions (i) comprise inorganic powders, optional organics, and liquid vehicle constituents for forming plasticizable mixtures, and (ii) are convertible through firing to a ceramic material having a predominant crystal phase selected from the group consisting of cordierite, aluminum titanate, mullite, and silicon carbide.

9. A method in accordance with claim 8 wherein the ceramic material has the configuration of a ceramic honeycomb product.

10. A method in accordance with claim 8 wherein the first ceramic composition is convertible through firing to a ceramic material having a predominant crystal phase of aluminum titanate, wherein the second ceramic composition is convertible through firing to a ceramic material having a predominant crystal phase of cordierite, and wherein the cross-contaminant is an oxide or oxide mixture selected from the group of calcium oxide, strontium oxide, and combinations thereof.

11. A method in accordance with claim 8 wherein the first ceramic composition is convertible through firing to a ceramic material having a predominating crystal phase of cordierite, wherein the second ceramic composition is convertible through firing to a ceramic material having a predominating crystal phase of aluminum titanate, and wherein the cross-contaminant is magnesium oxide.

12. A method for reducing cross-contamination in a ceramic production line comprising:
conveying a shapeable mixture incorporating a marking material through the production line;
substantially purging the production line of the mixture;
at least partially disassembling the production line and identifying contamination sites within the line that retain residual marking material following the purging step; and
mapping the contamination sites for selective treatment and removal of any contaminating material from a first ceramic production run prior to the initiation of a second ceramic production run.

13. A method for reducing cross-contamination as between multiple ceramic compositions selected for manufacture on a single production line comprising:
(a) identifying cross-contamination sites within the production line;
(b) collecting a set of samples of at least one of the ceramic compositions from at least one of the cross-contamination sites in the course of production of the at least one ceramic composition on the production line:
(c) analyzing the set of samples to establish levels of a cross-contaminant therein, and based on the levels of cross-contaminant analyzed in the set of samples, selecting a corrective action step from the group of:
(i) selectively extracting additional samples of the second ceramic composition from the cross-contamination sites and determining the cross-contamination levels of the additional samples; or
(ii) segregating finished products of the second ceramic composition taken from the production line pending testing of a physical property of the finished products; or
(iii) purging the production line of the second ceramic composition.

14. A method in accordance with claim 13 wherein the step of identifying cross-contamination sites within the production line comprises the steps of conveying a plasticized material incorporating a marking additive through the production line; purging the production line of the plasticized material, and scanning the production line for residue of the marking additive.

15. A method for projecting at least one physical property of a ceramic product made from a ceramic precursor containing a known concentration of a contaminant comprising the steps of:
preparing a benchmark series of ceramic products of a common base composition but differing concentration levels of the contaminant;
measuring the at least one physical property for each of the series of ceramic products;
constructing a statistical model correlating the differing concentration levels of the contaminant with measured values of the at least one physical property of the benchmark series of ceramic products;
using the statistical model to project the physical property for a further ceramic product of the base composition to be made from a ceramic precursor incorporating the known concentration of the contaminant.

16. A method in accordance with claim 15 wherein the contaminant in the ceramic precursor originates through contact with a second precursor for a second ceramic product of a composition differing from the common base composition.

17. A method in accordance with claim 15 wherein the ceramic product is a ceramic honeycomb of a composition incorporating a predominant crystal phase selected from the group consisting of cordierite, aluminum titanate, and mullite.

18. A method in accordance with claim 15 wherein the contaminant includes an alkaline earth metal element.

19. A method in accordance with claim 18 wherein the differing concentration levels of the contaminant in the benchmark series of ceramic products range up to a value not exceeding 1% by weight

20. A method in accordance with claim 15 wherein the projected physical property of the ceramic product is a property selected from the group consisting of: a product diameter or height, a product porosity characteristic, and a product thermal expansion coefficient.

21. A method in accordance with claim 15 wherein multiple physical properties are projected through the use of multiple statistical models constructed from the measurement of multiple physical properties on the series of ceramic products.

22. A method in accordance with claim 15 wherein the ceramic product is an aluminum titanate honeycomb, wherein the contaminant is magnesium oxide, and wherein the at least one physical property is a coefficient of thermal expansion of the cordierite honeycomb as measured at a temperature of 800° C. or 1000° C.

23. A method in accordance with claim 15 wherein the ceramic product is a cordierite ceramic honeycomb, wherein the contaminant is an alkaline earth metal oxide selected from the group consisting of strontium oxide and calcium oxide, and wherein the at least one physical property is selected from the group consisting of fired honeycomb product height or fired honeycomb product diameter.
